(19) United States
(12) Patent Application Publication
(10) Pub. No.: US 2003/0076874 A1
(43) Pub. Date: Apr. 24, 2003

(54) Reverse synchronization method in a wireless system

(75) Inventors: Daoben Li, Beijing (CN); Weidong Chen, San Jose, CA (US); Haiyang Gao, San Jose, CA (US); Shiu Ming Joseph Ho, San Jose, CA (US); Yongsheng Zhang, Beijing (CN); Yuanhua Deng, San Jose, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Linkair Communications, Inc.

(21) Appl. No.: 10/308,535

(22) Filed: Dec. 3, 2002

Related U.S. Application Data
(63) Continuation of application No. PCT/CN00/00141, filed on Jun. 5, 2000.

(51) Int. Cl. H04B 1/707; H04B 1/69

(52) U.S. Cl. 375/145

(57) ABSTRACT

A reverse synchronization method, which is used in a wireless system utilizing orthogonal spreading codes with Interference Free Window characteristic, wherein the transmission time of the signal from a remote unit is adjusted with respect to a predetermined Interference Free Window [−n, +n], such that the arrival time in a base station of the signal from the said remote unit falls within the said predetermined Interference Free Window. This eliminates inter-symbol interferences and multiple access interferences when multipath signals from a same remote unit and signals from different remote units arrive within an Interference Free Window.

### CROSS-REFERENCE TO RELATED APPLICATONS

This is a continuation application of PCT/CN00/00141, filed Jun. 5, 2000, which is incorporated herein by reference in its entirety.

### BACKGROUND OF THE INVENTION

1. Field of the Invention

The present invention relates generally to a method for establishing and maintaining reverse synchronization in a mobile and wireless communications network.

2. Description of Related Art

In a CDMA system, each remote unit modulates the data that it sends to a base station by a spreading code that is unique to the remote unit. The spread spectrum coded signals transmitted by different remote units may overlap in both time and frequency. When these signals arrive at the receiving base station, the data sent by a remote unit are obtained by correlating the received signal with the unique spreading code of the remote unit.

It is well known that the capacity of a CDMA system is limited by the interferences. The interferences include Inter-Symbol Interference (“ISI”) among multipath signals from a same remote unit, Multiple Access Interferences (“MAI”) among signals from different remotes units in the service area of a same base station, and Adjacent Cell Interference (“ACI”) among signals from neighboring base stations and the remote units that they serve.

In a PCT Application with the inventor, number and title of it respectively as Li Daoben, PCT-CN00/00028 and “A Scheme for Spread Spectrum Multiple Address Coding with Interference Free Window,” there is disclosed a kind of complementary orthogonal codes referred to here as LS codes. The LS codes have an “Interference Free Window” property, which is also referred to as “zero correlation window” property. As an illustration, consider the following four LS codes of length 8:

(C1, S1)=(++−+, +−−−)

(C2, S2)=(+++−, +−++)

(C3, S3)=(−+++, −−+−)

(C4, S4)=(−+−−, −−−+)

The cross-correlation of any two of these codes is zero when the time shift between the two codes is within the (inclusive) window [−1, +1], and the auto-correlation of any of these codes is zero except when there is no time shift. Thus, these four codes have an Interference Free Window of [−1, +1].

Similarly, the following LS codes of length 16 have an Interference Free Window of [−3, +3]:

(C1, S1)=(++−++++−, +−−−+−++)

(C2, S2)=(++−+−−−+, +−−−−+−−)

(C3, S3)=(+++−++−+, +−+++−−−)

(C4, S4)=(+++−−−+−, +−++−+++)

If we consider only (C1,S1) and (C2,S2), they have an Interference Free Window of [−7,+7].

Thus, when remote units transmit to a base station signals that are modulated using a set of LS codes that have a Interference Free Window of [−n, +n], these signals will not interfere with each other as long as they arrive at the receiving base station within n chips with respect to each other. This eliminates inter-symbol interferences and multiple access interferences when multipath signals from a same remote unit and signals from different remote units arrive within an Interference Free Window.

Hereinafter the wireless systems, the signals, the air interface which utilize LS codes as the orthogonal spread codes will be respectively referred to as LS coded wireless systems, LS coded signals, and LS coded air interface.

Hereinafter the wireless systems, the signals, the air interface which utilize orthogonal spread codes with an Interference Free Window (“IFW”) property will be respectively referred to as IFW wireless systems, IFW signals, and IFW air interface.

### SUMMARY OF THE INVENTION

An object of the present invention is a communications system and a synchronization method where signals from remote units arrive at a base station within an Interference Free Window.

According to the present invention, a reverse synchronization method is provided, which is used in a wireless system utilizing orthogonal spreading codes with an Interference Free Window characteristic, wherein the transmission time of the signal from a remote unit is adjusted with respect to a predetermined Interference Free Window [−n, +n], such that the arrival time in a base station of the signal from the said remote unit falls within the said predetermined Interference Free Window.

The said orthogonal spreading codes can be LS codes.

In order to estimate the arrival time of the signal, a reference time window [t1, t2] could be determined by the base station with respect to the Interference Free Window [−n, +n] and a set of remote units that are currently connected to the base station. The transmission time of the signal from a remote unit is adjusted, such that the arrival time in the said base station of the signal from the said remote unit falls within the said reference time window [t1, t2].

Preferably, in establishing reverse synchronization, it could be comprised of the following steps:

The base station transmits a synchronization signal on the downlink;

Each remote unit that attempts to establish reverse synchronization with the base station transmits an access signal to the base station on the uplink;

The base station determines the arrival time of each access signal from a remote unit; and

The base station sends the time difference between the arrival time and the reference time window [t1, t2] to the remote unit on the downlink, while the remote unit adjusts the transmission time of its access signal according to the time difference.

Preferably, in maintaining reverse synchronization maintenance could be comprised of the following steps:

The base station determines the arrival times of the control and traffic signals from all remote units within the same group that require an Interference Free Window [−n, +n]; and

The base station sends time adjustments to remote units in the group whose transmission time should be adjusted, and the corresponding remote units adjust their transmission time for control and traffic signals accordingly.

The use of a reference time window leads to faster reverse synchronization compared to synchronization with respect to a single time point. Consequently different remote units may maintain reverse synchronization with respect to different reference time windows.

### BRIEF DESCRIPTION OF THE ATTACHED DRAWINGS

The accompanying drawings which are incorporated in and constitute a part of this specification, illustrate particular embodiments of the invention, and together with the description, serve to explain, but not restrict, the principles of the invention.

FIG. 1 illustrates an exemplary cellular system with multiple cells.

FIG. 2 illustrates an exemplary base station and a plurality of remote units in one cell.

FIG. 3 illustrates the structure of a Forward Sync Channel on the downlink in an embodiment of the present invention.

FIG. 4 illustrates the structure of the Reverse Sync Channel on the uplink in an embodiment of the present invention.

FIG. 5 illustrates the arrival times of signals from four different remote units that are normalized to the beginning of a frame according to an embodiment of the present invention.

### DETAILED DESCRIPTION OF THE INVENTION

According to the present invention, as embodied and broadly described herein, systems and methods are provided for establishing and maintaining reverse synchronization of remote units where signals from remote units in the same cell arrive at the base station in the cell within a zero-correlation window. The said system comprises the following components:

A cellular system with multiple cells serving a geographic area;

A base station in each cell that uses complementary orthogonal codes and that transmits code division multiplexed and time division multiplexed signals to remote units;

A plurality of remote units that use complementary orthogonal codes and that transmit spread spectrum signals through code division multiple access and time division multiple access;

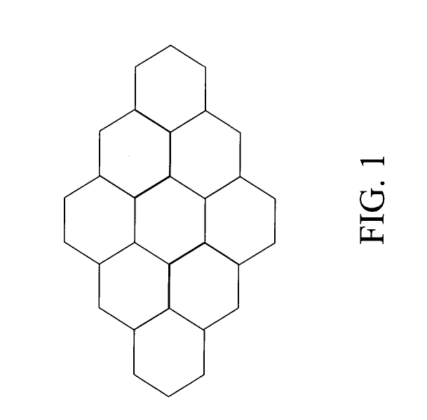

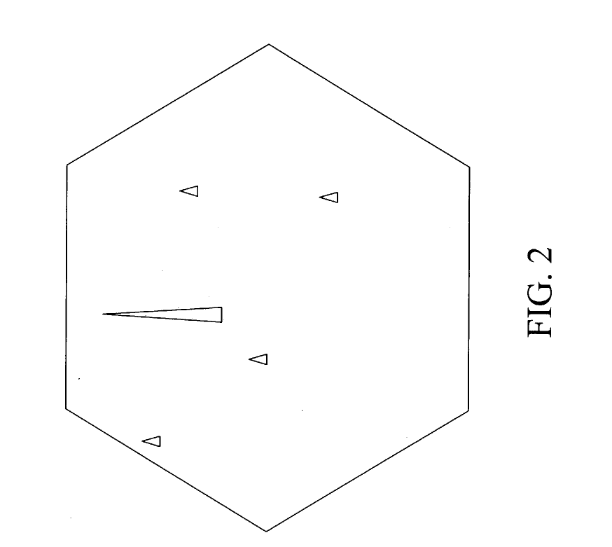

A preferred embodiment of a communications system of the present invention, as shown in FIG. 1, includes a cellular system comprising multiple cells that serve a geographic area, a base station in each cell providing a downlink signal to remote units in the cell, and a plurality of remote units in each cell. FIG. 2 shows a base station and a plurality of remote units in a cell. The base station includes transmitters and receivers and appropriate processors for implementing the methods of the present invention. Each of the plurality of remote units includes a transmitter, a receiver, and an appropriate processor for implementing the methods of the present invention.

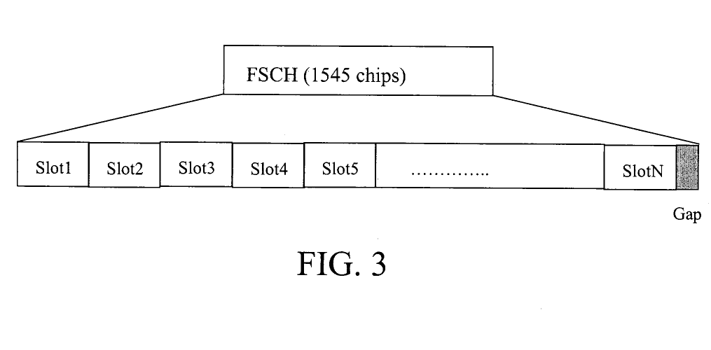

FIG. 3 illustrates the structure of the Forward Sync Channel on the downlink in a preferred embodiment of the present invention. It is divided into a number (N) of slots of equal length, followed by a gap. Each slot is spread by using a spreading code. To reduce the adjacent cell interference, different base stations in different nearby cells should use different spreading codes for the Forward Sync Channel. For example, the Forward Sync Channel can be divided into 12 slots of 128 chips each followed by a gap of 9 chips, and each slot can be spread by using an LS code of length 128 or some transformation of an LS code as disclosed in PCT-CN98/00028.

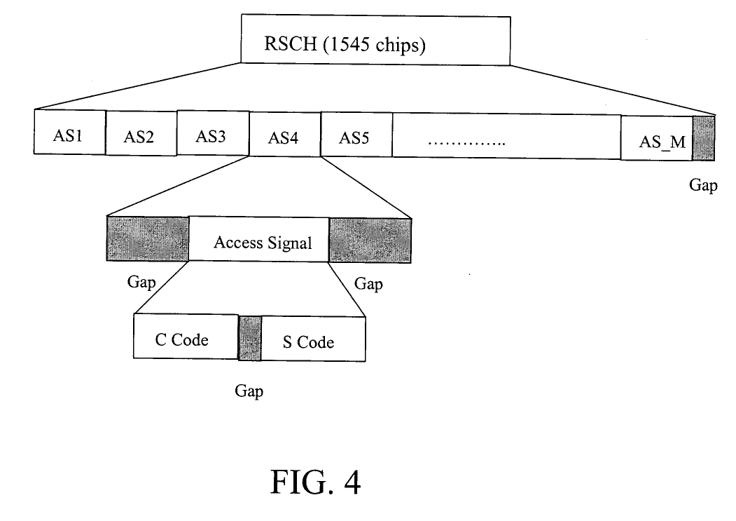

FIG. 4 illustrates the structure of the Reverse Sync Channel on the uplink in a preferred embodiment of the present invention. It is divided into a number (M) of access slots (“AS”) of equal length, followed by a gap. Each access slot is used by remote units to send access signals to a base station for reverse synchronization. As illustrated in FIG. 4, an access slot contains an access signal, with gaps on both sides of an access signal to provide room for adjusting the transmission time of an access signal in order for a remote unit to achieve reverse synchronization with a base station. An access signal can be a spread spectrum signal using an orthogonal code, such as an LS code or any transformation of an LS code. FIG. 4 illustrates a preferred embodiment of an access signal that is spread using an LS code with some gap between the C code and the S code.

The length of an access slot is determined according to the length of an access signal and the maximum delay from a remote unit to a base station when the remote unit attempts to establish reverse synchronization with the base station.

To reduce the adjacent cell interference, different, nearby base stations should use different spreading codes for access signals on the Reverse Sync Channel.

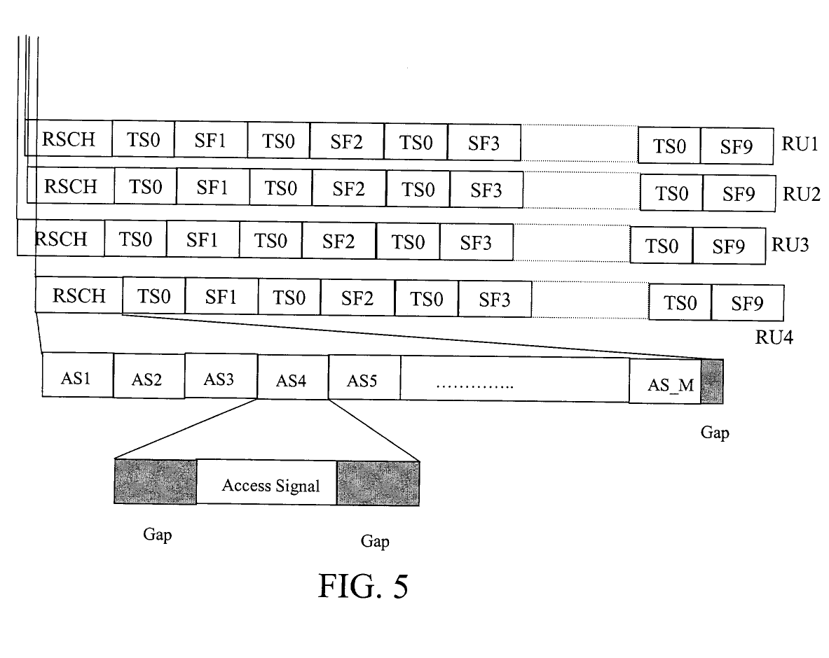

When considering the arrival time of a signal from a remote unit that transmits in only designated time slots and sub-frames, the arrival time is normalized to the beginning of the 20 ms frame on the uplink. FIG. 5 illustrates the arrival times of signals from four different remote units that are normalized to the beginning of a 20 ms frame in an embodiment of the present invention. Remote units RU1, RU2, and RU3 are currently connected to a base station and are transmitting control and traffic signals within their allocated time slot and sub-frame using their allocated spreading codes. The transmissions from RU1 and RU3 overlap in time, but they use different spreading codes. Remote unit RU4 attempts to establish reverse synchronization by transmitting an access signal, where the access signal is always considered to be in the middle of an access slot when normalizing the arrival time of an access signal to the beginning of a 20 ms frame on the uplink.

A set of remote units are considered to be synchronized with each other with respect to a zero-correlation window [−n, +n] if the time difference between the arrival times of any two remote units in the set is no more than n chips.

The preferred embodiment of a reverse synchronization method comprises the following steps.

1. A base station transmits a synchronization signal on the downlink on the Forward Sync Channel;

2. Each remote unit that attempts to establish reverse synchronization with the base station randomly chooses an access slot in the Reverse Sync Channel and transmits an access signal to the base station on the uplink;

3. The base station determines the arrival time of each access signal from a remote unit;

4. With respect to a given zero-correlation window [−n, +n], and a set of remote units that are currently connect to the base station and are synchronized with respect to the zero-correlation window [−n, +n], (i.e., the time difference between the arrival times of any two currently connected remote units is no more than n chips), the base station determines a reference time window [t1, t2] such that if the arrival time of the access signal from a remote unit falls within [t1, t2], then it is synchronized with all currently connected remote units with respect to the zero-correlation window [−n, +n];

5. If the arrival time of the access signal from a remote unit falls within the time interval [t1, t2], then the remote unit has achieved reverse synchronization with the base station with respect to the zero-correlation window [−n, +n], and the base station sends to the remote unit any information of the spreading code and time slots and sub-frames for the remote unit to transmit control and traffic data and the remote unit starts to transmit control and traffic data using the allocated spreading code and allocated time slots and sub-frames; and

6. If the arrival time of the access signal from a remote unit falls outside of the time interval [t1, t2], the base station computes a time difference between the arrival time and the time interval [t1, t2] and sends the time difference to the remote unit on the downlink; the remote unit adjusts the transmission time of its access signal and go to step 2.

The preferred embodiment of a communication system of the present invention provides both time division multiple access using time slots and sub-frames and code division multiple access using LS codes. Remote units within a cell served by a base station may have experience different time dispersion and propagation environments. The remote units can be put into different groups with different zero-correlation windows. For example, remote units that are close to a base station can be put into a group with a zero-correlation window of [−1, +1] since the maximum time dispersion for these remote units may be small, and remote units that are farther away from a base station can be put into another group with a zero-correlation window of [−3, +3]. These two different groups of remote units can be allocated control and traffic channels in separate time slots and sub-frames. As an example, the nine time slot (TS0)—sub-frame pairs can be divided into three groups, one for remote units that have the best propagation environment with a zero-correlation window of [0, 0], another for remote units that require a zero-correlation window of [−1, +1], and another for remote units that require a zero-correlation window of [−3, +3]. The multipath access signals from a same remote unit can be used by a base station to decide which group the remote unit belongs to, which time slots and sub-frames can be allocated to the remote unit, and to which zero-correlation window it needs to establish reverse synchronization.

After a remote unit establishes reverse synchronization with a base station and starts to transmit control and traffic signals to the base station, the reverse synchronization can be maintained with respect to a zero-correlation window of [−n, +n] within a group of remote units using the following preferred embodiment of a synchronization maintenance method:

1. A plurality of remote units that are connected to a base station transmit control and traffic signals to a base station using some spreading code in some designated time slots and sub-frames;

2. The base station determines the arrival times of the control and traffic signals from all remote units within the same group that require a zero-correlation window of [−n, +n]; and

3. If there is no pair of remote units in the group whose arrival times are more than n chips apart, the reverse synchronization is maintained with respect to a zero-correlation window of [−n, +n]; otherwise, the base station sends time adjustments to remote units in the group whose transmission time should be adjusted, and the corresponding remote units adjusts their transmission time for control and traffic signals accordingly.

The use of a reference time window leads to faster reverse synchronization compared to synchronization with respect to a single time point. Consequently different remote units may maintain reverse synchronization with respect to different reference time windows. It will be apparent to those skilled in the art that various modifications can be made to the reverse synchronization method of the present invention without departing from the scope and spirit of the present invention. It is intended that the present invention covers modifications and variations of the system and methods provided they fall within the scope of the claims and their equivalents. Further, it is intended that the present invention cover present and new applications of the system and methods of the present invention.

What is claimed:

1. A reverse synchronization method, which is used in a wireless system utilizing orthogonal spreading codes with Interference Free Window characteristics, wherein:
a signal's transmission time from a remote unit is adjusted with respect to a predetermined Interference Free Window [−n, +n], such that the signal's arrival time in a base station from the remote unit falls within the predetermined Interference Free Window.

2. The method of claim 1, wherein said orthogonal spreading codes are LS codes.

3. The method of claim 1, wherein a reference time window [t1, t2] is determined by the base station with respect to the Interference Free Window [−n, +n] and a set of remote units that are currently connected to the base station, and the signal's transmission time from a remote unit is adjusted, such that the signal's arrival time in the said base station from the said remote unit falls within said reference time window [t1, t2].

4. The method of claim 3, further comprising the following steps in establishing reverse synchronization:
transmitting a synchronization signal on the downlink by the base station;
transmitting an access signal to the said base station on the uplink by each remote unit that attempts to establish reverse synchronization with the base station;
determining the arrival time of each access signal from a remote unit by the base station; and
sending the time difference between the arrival time and the reference time window [t1, t2] to the remote unit on the downlink by the base station, while the remote unit adjusts the transmission time of its access signal according to the said time difference.

5. The method of claim 1, further comprising the following steps in reverse synchronization maintenance:
determining the arrival times of the control and traffic signals by the base station from all remote units within the same group that require a Interference Free Window [−n, +n];
sending time adjustments to remote units in the group whose transmission time should be adjusted from the base station, and the corresponding remote units adjusting their transmission time for control and traffic signals accordingly.
